(19) United States
(12) Patent Application Publication
(10) Pub. No.: US 2011/0052059 A1
(43) Pub. Date: Mar. 3, 2011

(54) GENERATING IMAGE HISTOGRAM BY PARALLEL PROCESSING

(75) Inventors: Manoj Mathew, Tustin, CA (US); Allison Bajo, Carson, CA (US)

(73) Assignee: CANON KABUSHIKI KAISHA, Tokyo (JP)

(21) Appl. No.: 12/549,329

(22) Filed: Aug. 27, 2009

(51) Int. Cl. G06K 9/00

(52) U.S. Cl. 382/168

(57) ABSTRACT

A histogram is generated. An image is input, and a pixel value is assigned to each pixel of the input image. A set of bin indexes is defined, with each bin index representing one or more possible numerical values for a pixel. A parallel sort is applied to the pixel values in order to generate a set of sorted pixel values. A parallel search is applied to the sorted pixel values for each bin index to find the position of the bin index in the sorted pixel values. A number of pixels in a bin corresponding to each bin index is generated, based on the difference between the position of the bin index in the sorted pixel values and the position of a subsequent bin index in the sorted pixel values. The histogram is generated based on the number of pixels in the bins corresponding to each bin index.

### FIELD

The present disclosure relates to processing digital images to generate a histogram of pixel values. More specifically, the disclosure relates to a process for generating a histogram of pixel values from image data using methods which are particularly suited for parallel processing.

### BACKGROUND

In image processing, it is common to generate a histogram as a graphical summarization of a distribution of image data. The histogram of an image includes a discrete array of bins (or “buckets”) on the horizontal axis, each representing a certain range of pixel values. The vertical axis represents the number of pixels whose values fall within each respective bin. Image histograms are useful for summarizing and sorting image data in fields such as real-time color correction, tone mapping, and medical imaging.

Numerous methods exist for generating histograms from pixel data. One method creates a histogram after reading back a downsampled version of a framebuffer from a Graphics Processing Unit (GPU). In another method, a pixel shader fetches a pixel and eliminates the fragment being processed if the luminance value is not within a bin range. Some algorithms divide the input images into tiles with sizes depending on the bit width prior to processing. There have also been attempts to use data scattering with a vertex buffer or vertex texture fetch feature (in a GPU) to collect pixel information for the histogram.

However, the conventional methodologies all have significant drawbacks. For example, a number of the existing approaches raise thread synchronization issues between a CPU and a GPU, and increase overhead of communications across threads. Some methods utilize the vertex shader of the GPU instead of the much faster pixel shader. Other methods lead to limits on the number of bins that can be created, due to potential issues with shared memory and implementation. In addition, certain methods perform less efficiently if the data is not uniform or is not of a Gaussian distribution.

### SUMMARY

The present disclosure addresses the foregoing by generating a histogram from an input image using a parallel sort and a parallel search.

Thus, in an example embodiment described herein, a histogram of an image is generated. The image is input, and a pixel value is assigned to each pixel of the input image. A set of bin indexes for the histogram is defined, with each bin index representing one or more possible numerical values for a pixel. A parallel sort is applied to the pixel values in order to generate a set of sorted pixel values. A parallel search is applied to the sorted pixel values for each bin index, using the bin index as the target of the parallel search, in order to find the position of the bin index in the sorted pixel values. For each bin index, a number of pixels in a bin corresponding to the bin index is generated, based on the difference between the position of the bin index in the sorted pixel values and the position of a subsequent bin index in the sorted pixel values. The histogram is generated based on the respective number of pixels in each bin corresponding to each bin index, and the generated histogram is stored in a memory.

By performing the parallel sort and parallel search on the pixel values of the input image, many of the disadvantages of other histogram generation methods can be reduced. In particular, the histogram can ordinarily be created more quickly and efficiently. In addition, the image data ordinarily does not require any pre-processing or segmentation, nor any thread overhead to account for shared memory and/or synchronization between threads. Moreover, the memory required for generating the histogram can ordinarily be reduced, allowing extra space for more histogram bins to represent more detailed images. Additionally, the histogram can ordinarily be generated without regard to the particular type of hardware being used.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 illustrates an example embodiment of computing equipment in which aspects of the present disclosure may be practiced.

FIG. 2 is a block diagram depicting the architecture of the computing equipment shown in FIG. 1.

FIG. 3 depicts a use case diagram for a histogram, a cumulative histogram, and a clipped histogram.

FIG. 4 illustrates examples of a histogram and a cumulative histogram.

FIG. 5 is a flowchart depicting an example process for generating a histogram.

FIG. 6 illustrates examples of pixel values stored with pixels of an input image.

FIG. 7 is a view for explaining a bitonic merge sort of pixel values.

FIG. 8 depicts a table representing bin indexes of a histogram, prior to filling in the number of pixels in each bin.

FIG. 9 depicts the table of FIG. 8, after filling in the number of pixels in each bin of the histogram.

FIG. 10 depicts an example of a two-dimensional data texture for storing a histogram.

FIG. 11 illustrates an example of clipping a cumulative histogram by specifying bin numbers.

FIG. 12 illustrates an example of clipping a cumulative histogram by specifying frequencies.

FIG. 13 depicts the table of FIG. 9 after the bin-based clipping shown in FIG. 11.

FIG. 14 depicts the table of FIG. 9 after the frequency-based clipping shown in FIG. 12.

FIG. 15 illustrates an example of a data structure storing a cumulative histogram.

### DETAILED DESCRIPTION

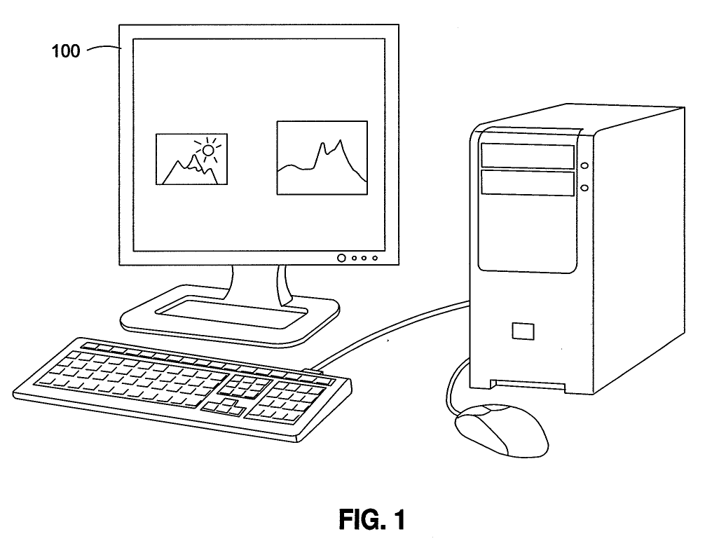

FIG. 1 illustrates an example embodiment of computing equipment in which aspects of the present disclosure may be practiced. As shown in FIG. 1, computer 100 displays an input image on the left side of a screen, and an image histogram on the right side of the screen.

While FIG. 1 depicts a computer, computing equipment for practicing aspects of the present disclosure can be implemented in a variety of embodiments. For example, in an image processing environment, the computing equipment might be included in a digital camera or digital video recorder. In a medical imaging environment, the computing equipment might be included as part of a larger imaging machine such as a CT scanner or ultrasound scanner. Other embodiments are possible according to the application and environment.

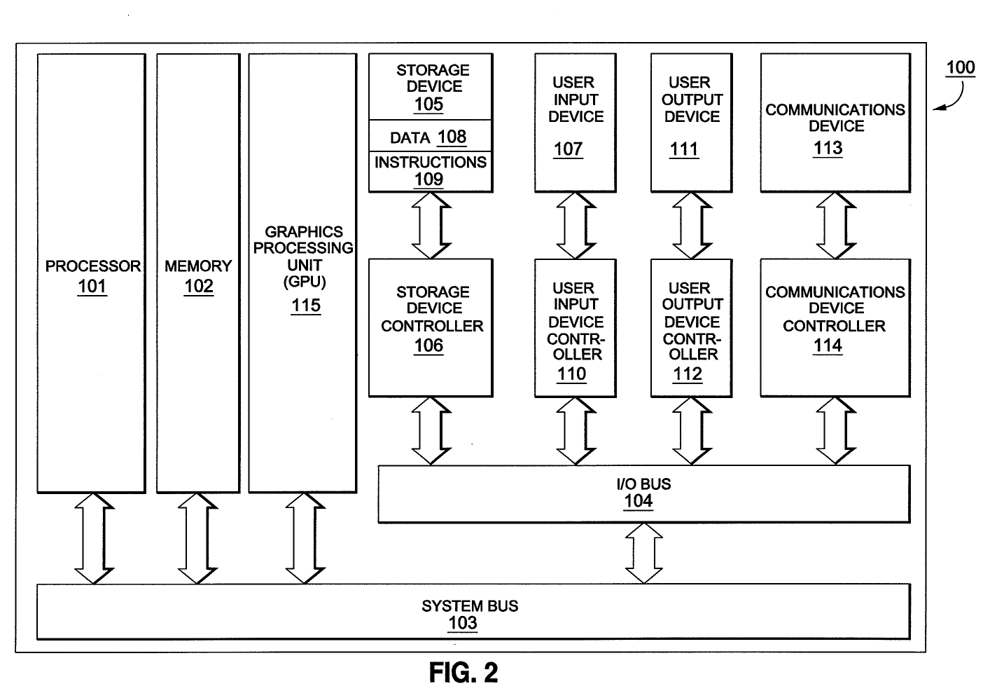

FIG. 2 is a block diagram of the architecture of computer 100. The elements of computer 100 may be implemented using hardcoded computational modules or other types of circuitry, or a combination of software and circuitry. Host computer 100 includes a processor 101 coupled to a memory 102 via system bus 103. Memory 102 can include, for example, a RAM, SDRAM, DDR SRAM, or flash memory. In operation, processor 101 loads program instructions from storage device 105 into memory 102. Processor 101 executes the loaded program instructions to implement a process for generating an image histogram by using parallel processing, as described in more detail below. For purposes of this disclosure, an input image can be an image loaded from memory 102 or another storage device.

Processor 101 is also coupled to external Input/Output (I/O) devices via the system bus 103 and an I/O bus 104. More specifically, the processor may be coupled to a user output device 111 via a user output device controller 112 coupled to the I/O bus 104.

Output device 111 can include hardware such as a display monitor or a screen. Output device 111 may display an input image along with a histogram generated from the input image. Alternatively, output device 111 may display only one of the input image and the histogram at a time. Output device controller 112 could be, for example, a separate video card or graphics controller. The processor 101 may be further coupled to a user input device 107 via a user input device controller 110 coupled to the I/O bus 104. Input devices can include hardware such as, for example, a keyboard, a mouse, a joystick, a trackball or a game controller, which allow a user of host computer 100 to input commands. In this embodiment, input device 107 could also include a scanner for inputting images, from which histograms are generated.

A storage device 105 having computer-readable media is coupled to the processor 101 via a storage device controller 106, the I/O bus 104 and the system bus 103. For example, storage device 105 could include a hard disk drive. In one implementation, storage device 105 is used by processor 101 to store and read data 108 and program instructions 109 to be loaded into memory 102 in order to execute a process for generating an image histogram using parallel processing, as described more fully below.

The processor 101 is further coupled to a communications device 113 via a communications device controller 114 coupled to the I/O bus 104. The processor uses the communications device 113 to communicate with another device. More specifically, communication device 113 allows computer 100 to receive images over a network. Communications device 113 may be a network interface card (NIC). Thus, in one example, computer 100 obtains an image from another device over a network.

Graphics Processing Unit (GPU) 115 is coupled to processor 101, memory 102, and I/O bus 104 via system bus 103. GPU 115 is a dedicated graphics rendering device. GPU 115 may be particularly well suited for parallel processing, especially in an image processing environment. GPU 115 may also control its own separate partition of memory 102 for processing image data. GPU 115 may operate in coordination with processor 101 to execute program instructions to implement a process for generating an image histogram by parallel processing, or may perform these functions on its own. For purposes of simplicity, GPU 115 is shown as a separate unit in FIG. 2. However, several other embodiments of GPU 115 are possible. For example, processor 101 may include or itself comprise GPU 115. GPU 115 could also sit on top of a video card, or could be integrated directly into the motherboard. GPU 115 could also be integrated in, for example, user output device controller 112.

As indicated above, a histogram of an image includes a discrete array of bins (or “buckets”) on the horizontal axis, each representing a certain range of pixel values. The vertical axis represents the number of pixels whose values fall within the range for each respective bin.

The value of a pixel (e.g., ‘0’, ‘1’, ‘500’) determines the color of the pixel. The number of distinct colors that can be represented by a pixel depends on the number of bits per pixel (bpp). Generally, for monochrome images, each pixel is stored as a single bit, and therefore each pixel has two possible pixel values (0 or 1). For color images, every pixel in the image is designated by a color which consists of a combination of primary colors, namely red, (R) green (G) & blue (B). Each additional bit doubles the number of colors available, so a 2 bpp image can have 4 colors, and a 3 bpp image can have 8 colors, 8 bpp, 28=256 colors, and so on. Another common bit depth is “16-bit” (16 bpp), with 65,536 colors. A RGB histogram depicts how many of the pixels fall within different parts of the range of possible pixel values.

In one embodiment, a separate histogram can be generated for each channel (R, G, B) of the input image, along with a composite histogram representing the combination of the channels. Moreover, in one example, each of the channels can be assigned a weight to be used in the calculation of the composite histogram. For example, weights could be assigned to one or more channels by a user, by the application, or automatically based on the characteristics of the input image.

Generally, in the creation of a histogram, bin numbers (H) and the input image size (Hin, Win) are provided as external parameters. If the possible pixel values of an input image exist in E numbers, the acceptable range of pixel values is 0˜E−1. This range (0˜E−1) is divided into H numbers bin equally, and they are treated as bin [0], bin [1], . . . , bin [H−1] in ascending order of pixel value from the lowest. Therefore, the pixel value p that corresponds to bin [x] is expressed by the following formula:

$$\frac{E \times x}{H} \leq p < \frac{E \times ( x + 1 )}{H}$$

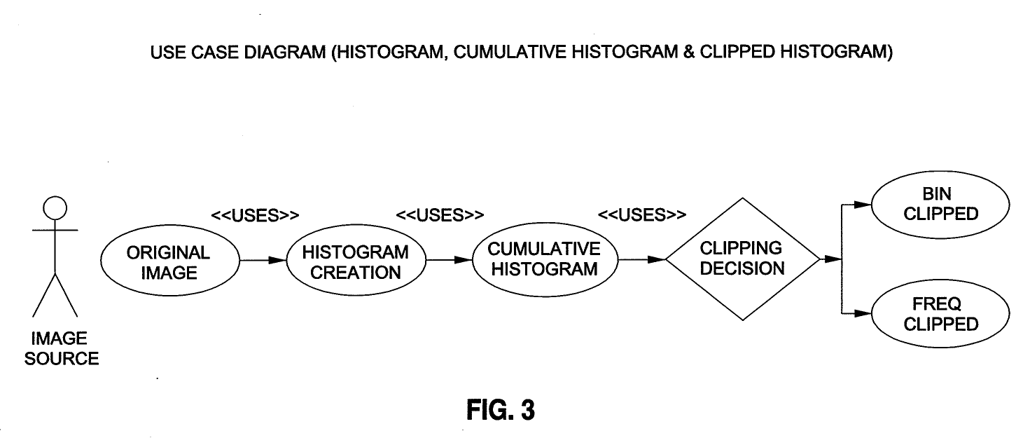

FIG. 3 depicts a use case diagram for a histogram, a cumulative histogram, and a clipped histogram. In the example of FIG. 3, an actor “Image Source” performs the act of obtaining an original image. The original image is used to create a histogram. The histogram is used to create a cumulative histogram. The cumulative histogram is used by a clipping decision to clip the cumulative histogram either by bin or by frequency. Each of these processes will be described in more detail below.

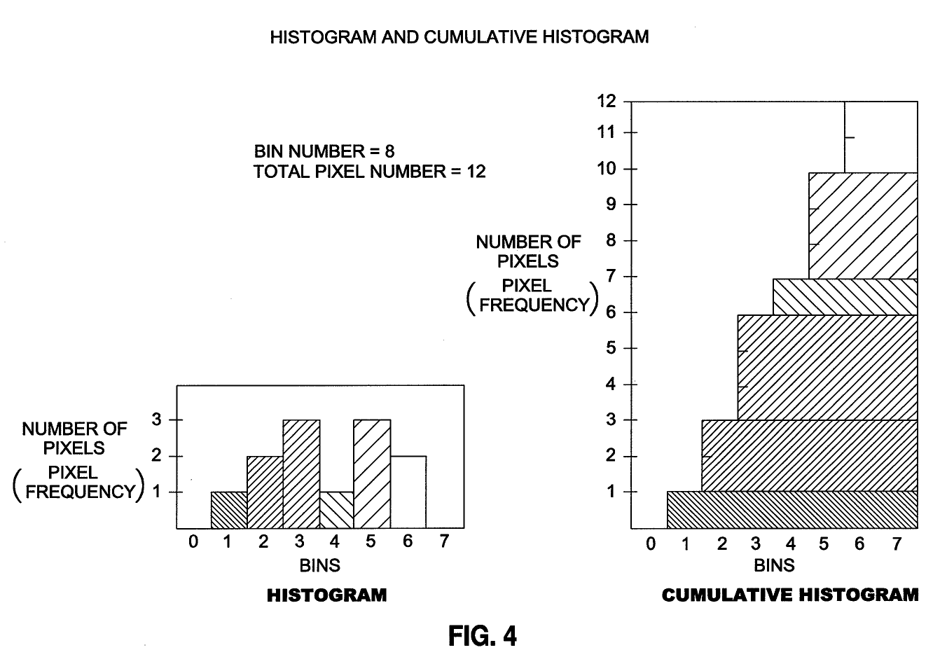

FIG. 4 depicts examples of a histogram where the total number of bins is 8 (i.e., bins 0 to 7), and where the total number of sorted pixels is 12. Thus, in these examples, each of the 12 pixels has been sorted into the appropriate bin of ‘0’ . . . ‘7’, depending on the value of the pixel. From the histogram shown in FIG. 4, it can be seen that there are no pixels with pixel value ‘0’, there is 1 pixel with pixel value ‘1’, there are two pixels with pixel value ‘2’, and so on.

A cumulative histogram is also shown in FIG. 4. A cumulative histogram is a mapping that counts the cumulative number of pixels in all of the bins up to the specified bin. Thus, as seen in the cumulative histogram in FIG. 4, the number of pixels increases as the bin index increases.

A histogram or cumulative histogram can be very useful for analysis or manipulation of image data. As discussed above, however, the conventional methodologies for generating histograms have significant drawbacks, including thread synchronization issues, increased overhead of communications across threads, and limits on the number of bins that can be created, among others.

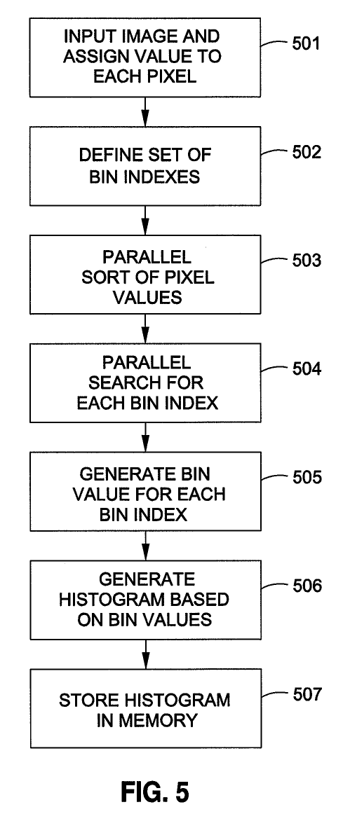

Therefore, generating a histogram using parallel processing will now be described with respect to FIGS. 5 to 10.

Briefly, in FIG. 5, a histogram of an image is generated. The image is input, and a pixel value is assigned to each pixel of the input image. A set of bin indexes for the histogram is defined, with each bin index representing one or more possible numerical values for a pixel. A parallel sort is applied to the pixel values in order to generate a set of sorted pixel values. A parallel search is applied to the sorted pixel values for each bin index, using the bin index as the target of the parallel search, in order to find the position of the bin index in the sorted pixel values. For each bin index, a number of pixels in a bin corresponding to the bin index is generated, based on the difference between the position of the bin index in the sorted pixel values and the position of a subsequent bin index in the sorted pixel values. The histogram is generated based on the respective number of pixels in each bin corresponding to each bin index, and the generated histogram is stored in a memory.

In step 501, an image is input and a pixel value is assigned to each pixel of the input image. In one embodiment, pixels of the image can be stored in two-dimensional data structure in correspondence to their respective positions in the image. This allows for a simplified input process, as each pixel of the input image is simply loaded into its corresponding position and assigned a pixel value.

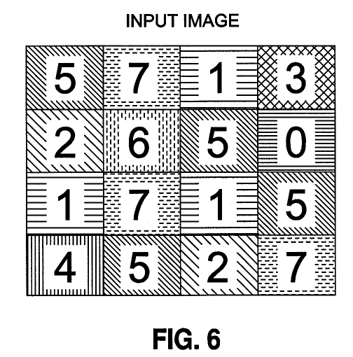

An simplified example of pixels and assigned pixel values is shown in FIG. 6, with pixel values ranging from ‘0’ to ‘7’. Of course, in most applications the pixel depth and the possible values for each pixel will be much more numerous, but for purposes of simplicity are not described in more detail herein.

In this embodiment, the inputting of the image and the assignment of pixel values comprise a single input step. Thus, there is no pre-processing or segmentation of the image prior to assigning pixel values.

In step 502, a set of bin indexes is defined for the histogram, with each bin index representing one or more possible numerical values for a pixel. The bin indexes define how the range of pixel values will be stored in the bins. For example, referring to FIG. 6, seven bins could be created with bin indexes 0 to 7 , thus defining respective bins for each of pixel values ‘0’, ‘1’, ‘2’, ‘3’, ‘4’, ‘5 ’, ‘6’ and ‘7’.

In the example of FIG. 6, each bin stores exactly one integer pixel value. Thus, in FIG. 6, each bin has a “width” of one pixel. In other embodiments, each bin index could be defined to represent a range of pixel values, such that the bin width of each corresponding bin is more than one integer value. For example, the first bin could store pixels with values ‘0’ to ‘2’, the second bin could store pixels with values ‘3’ to ‘5’, and so on.

In step 503, a parallel sort is applied to the pixel values, in order to generate a set of sorted pixel values. The parallel sort sorts the pixel values into ascending order. Examples of parallel sorting techniques include a parallel quick sort, a merge sort, a selection sort, a binary tree sort, a heap sort and a bucket sort, although other parallel sorting methods are possible. Applying the parallel sort to the pixel values shown in FIG. 6 would result in an set of sorted pixel values as follows: ‘0’, ‘1’, ‘1’, ‘1’, ‘2’, ‘2’, ‘3’, ‘4’, ‘5’, ‘5’, ‘5’, ‘5’, ‘6’, ‘7’, ‘7’, ‘7’.

In step 504, a parallel search is applied to the sorted pixel values for each bin index, using the bin index as the target of the parallel search, in order to find the position of the bin index in the sorted pixel values.

Examples of possible parallel searching techniques include a binary search, a parallel tree search and a hash table search, although other parallel searching methods are possible.

In step 505, the number of pixels in a bin corresponding to a bin index is generated for each bin index, based on the difference between the position of the bin index in the sorted pixel values and the position of a subsequent bin index in the sorted pixel values.

More specifically, since the list of pixel values is ordered, the number of pixels which belong to the bin corresponding to each bin index can be determined by locating the first occurrence of the bin index and the first occurrence of a subsequent bin index, and determining the number of integer pixel values between the two in the sorted list of values. For example, to find out the number of pixels with the value ‘2’, i.e., the number of pixels that should be stored in the bin with bin index ‘2’, a parallel search is conducted for the pixel value ‘2’ and the pixel value ‘3’. The resultant number of pixel values located between ‘2’ and ‘3’ is the number of pixels which should be stored at bin index ‘2’. In the example of FIG. 6, there are exactly two pixel values in the sorted list between the first occurrence of ‘2’ and the first occurrence of ‘3’. Thus, two pixels should be stored at bin index ‘2’.

Thus, in the example above, applying the parallel search technique for each bin index from ‘0’ to ‘7’ yields the number of pixels which belong in each respective bin.

In step 506, the histogram is generated based on the respective number of pixels in each bin corresponding to each bin index. In this example, the histogram shown in FIG. 4 corresponds to the input pixel values shown in FIG. 6.

In step 507, the generated histogram is stored in a memory. For example, the histogram could be stored in memory 102 of computer 100.

By performing the parallel sort and parallel search algorithms as described above, many of the disadvantages of other histogram generation methods can be reduced.

Once the histogram is generated, the histogram can be displayed on an output device (e.g., a display screen), and the histogram can be manipulated in order to effect changes in the image. For example, the generated histogram can be displayed on output device 111, and a user can use user input device 107 to perform commands for color correction or other applications, including generating a cumulative histogram or clipping the histogram as described more fully below. The resultant histogram corresponding to such changes can then be saved to a memory (such as memory 102) or a disk. The generated histogram can also be directly applied to an image for the purposes of image processing.

A more detailed example will now be described will now be described with respect to FIGS. 6 to 10. Specifically, in FIGS. 6 to 10, a bitonic merge sort is used as the parallel sort, and a binary search is used as the parallel search. As indicated above, however, other parallel sorts and searches are available, and the following is only intended to serve as an example.

Referring again to FIG. 6, pixels of the input image are input into a two-dimensional data structure and are respectively assigned pixel values.

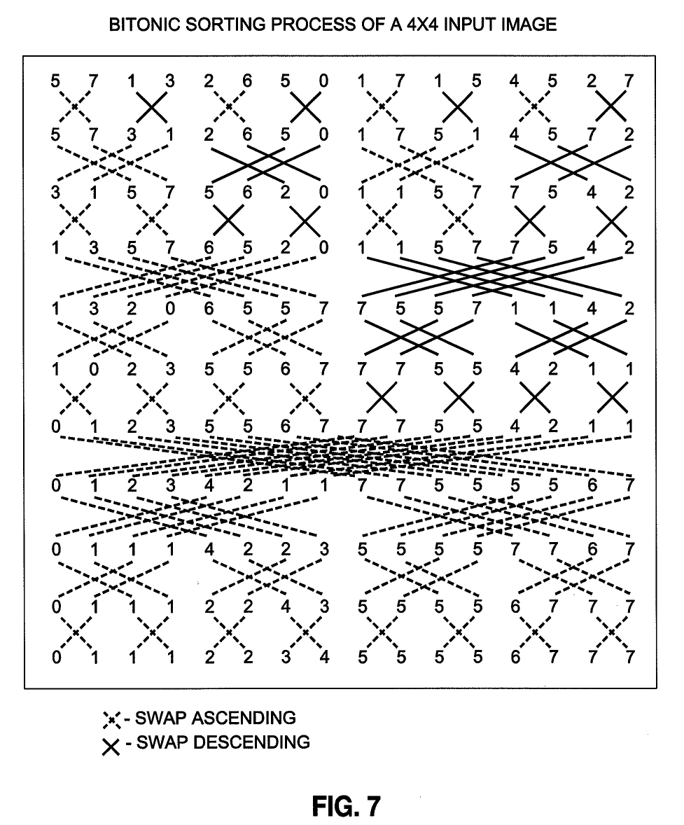

FIG. 7 depicts a bitonic merge sort as a sorting process for the pixel values shown in FIG. 6. At the top of FIG. 7 is the unsorted list of pixel values, while the bottom line of FIG. 7 depicts the sorted pixel values.

In more detail, a bitonic merge sort consists of bitonic sequences which are merged together at each stage. A bitonic sequence comprises two sub-sequences, one monotonically increasing and the other monotonically decreasing. The bitonic merge allows an array of n processors to sort n elements in O(log₂n) steps. Each step performs n comparisons and swaps. The algorithm can be implemented as a fragment program, with each stage of the sort performed as one rendering pass over a (m×n) pixel buffer.

For example, in a bitonic sequence of length 2n, there are elements in positions {0,2n}. During the bitonic merge sort, the elements in positions {0,2n } are divided into two halves, {0,n} and {n,2n}, such that each half is a bitonic sub-sequence. Then, elements in corresponding positions in the two halves are compared, and are exchanged if they are out of order.

Thus, the bitonic merge sort essentially operates according to a “divide & conquer” policy. In particular, only sub-sequences a power of two in length are sorted, so a sub-sub-subsequence of more than one element can always be divided into two halves. The lower half is sorted into ascending order and the upper half is sorted into descending order to get a bitonic sequence. A bitonic merge is performed to form the sequence, which gives a bitonic sequence in each half and all the larger elements in the upper half. Each half is recursively bitonically merged until all the elements are sorted.

Once the pixel values have been sorted into order, a binary search is used to obtain the number of pixels to be stored in each bin, by using the bin index as the target of the search.

More specifically, the binary search expects an ordered list of numbers in an ascending/descending order, which is what the bitonic merge sort provides. A binary search also performs a “divide & conquer” policy where the best performance is expected at the middle of the list.

For example, a binary search of [A, n, x] where A is the sorted set, n is the number of elements in the list and x is the search element can be depicted with the following pseudo-code:

```
low = 1,high = n
while (low ≦ high)
{
    mid = (low + high) / 2
    if ( A[mid] = x)
        return mid
    else if ( A[mid] < x)
        then low = mid + 1
    else high = mid − 1
    return “ x not exists”
}
```

Each of the bin indexes can be located according to this pseudocode. As mentioned above, to find the number of pixels which should be stored in the bin corresponding to a certain bin index, a binary search is conducted for that bin index, and for the bin index subsequent to that bin index. Thus, for example, to find out the number of pixels with the value ‘2’, i.e., the number of pixels that should be stored in the bin with bin index ‘2’, the binary search is conducted for the pixel value ‘2’ and the pixel value ‘3’. In the sorted list of pixel values shown in FIG. 7, the number of pixel values between the first occurrence of pixel value ‘2’ and the first occurrence of pixel value ‘3’ is two pixel values. Thus, two pixels should be stored in the bin corresponding to bin index ‘2’.

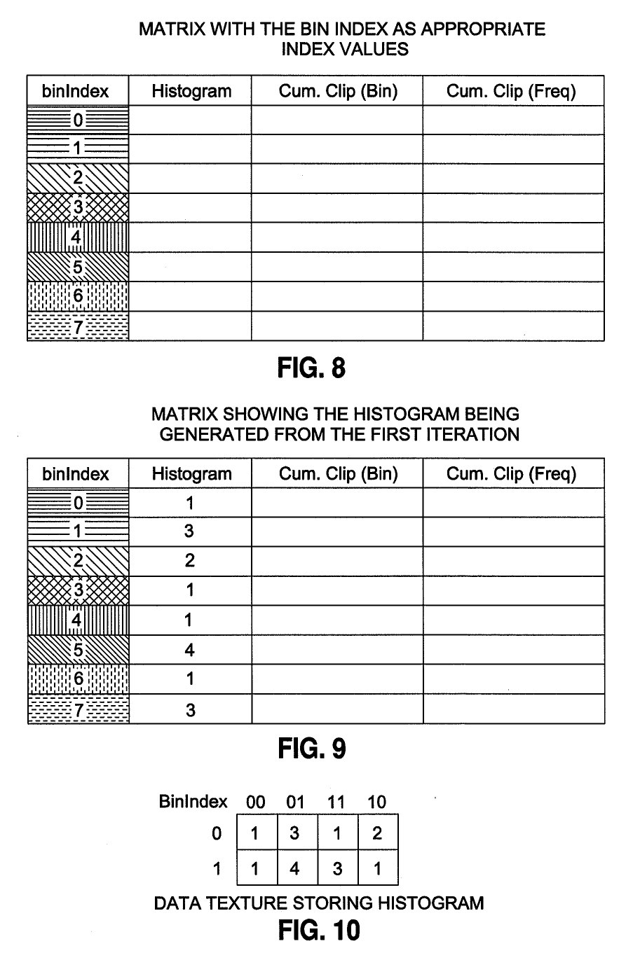

Turning to FIG. 8, a table is shown representing bin indexes of the histogram based on the input image of FIG. 6, prior to filling in the number of pixels in each bin. Specifically, “binIndex” values ‘0’ to ‘7’ are shown.

FIG. 9 depicts the table of FIG. 8, after filling in the number of pixels in each bin of the histogram as a result of the bitonic merge sort and the binary search discussed above.

The generated histogram can be stored in a two-dimensional data structure, such as a data texture which stores respective positions corresponding to each bin index together with the respective number of pixels corresponding to each bin index, as shown in FIG. 10. Thus, in the example of FIG. 10, each element of the two-dimensional data texture corresponds to a bin index and stores the number of pixels for that bin index. The respective position for each bin index in the texture is determined according to the numerical value of the bin index. In other words, the representation of the histogram flows from the data structure itself—the upper left corner is bin index ‘0’, the next over is ‘1’, and so on. In this regard, FIG. 10 depicts the different binIndex values in binary, although any other representation could be used.

By storing the histogram in a two-dimensional data structure, it is ordinarily possible to locate the number of pixels in a bin more quickly, rather than having to search sequentially through a list of bin indexes in order to find a bin index and its corresponding number of pixels. Accordingly, less memory is necessary to store the histogram, leaving more space available for more bins to store more detailed images. Moreover, certain types of data structures (such as the above-mentioned data texture) are particularly well suited for a graphics processing unit, such as GPU 115. In this regard, the data structure for storing the generated histogram can be the same type of data structure as the data structure which stores the input image.

The two-dimensional data structure could be extended to a three-dimensional data structure for more complex images. For example, if the input image is a three-dimensional image, a histogram could be stored in a three-dimensional data texture including a respective position in the texture for each bin index and its corresponding number of pixels.

Once a histogram has been generated, a cumulative histogram can be generated. As mentioned above, a cumulative histogram is a mapping that counts the cumulative number of observations in all of the bins up to the specified bin. An example of a cumulative histogram is shown in FIG. 4.

Generally, after checking the pixel value of pixels in the input image and calculating the number of pixels, i.e., the pixel frequency f for all of the bins, the following function calculates the cumulative frequency g for all bins. The cumulative frequency g(x) of bin [x] is calculated by the following formula with frequency f. Supposing that the pixel number that has pixel value p is Num(p), the cumulative frequency is expressed by the following formula:

$$f ( i ) = Num ( p \vert \frac{E \times i}{H} \leq p < \frac{E \times ( i + 1 )}{H} )$$

$$g ( x ) = {\sum }_{i = 0}^{x} f ( i )$$

The cumulative histogram is one-dimensionally sorted so as to that corresponding bins are expressed in ascending order.

Depending on the application, a user can choose to clip a cumulative histogram by bin, or, alternatively, by frequency. Clipping the histogram is useful for many real-life applications. For example, a doctor or radiologist could clip out certain colors of an x-ray to only show tissues with a certain brightness or color. In addition, in image processing and/or photography, clipping allows a user to reduce the effects of certain colors in an image. For example, if a stored image is “too red”, clipping can reduce the occurrence of extreme red pixel values. Clipping could also be performed on one channel of an RGB image (e.g., the red channel), and that channel could then be re-merged with the other color channels to form a changed composite histogram.

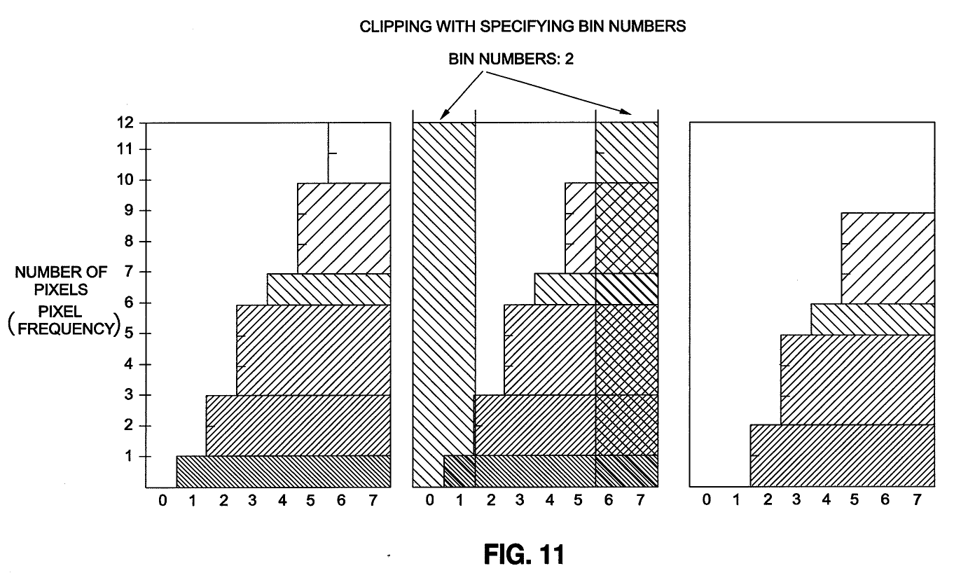

Clipping the cumulative histogram by bin or by frequency will now be described with respect to FIGS. 11 to 14.

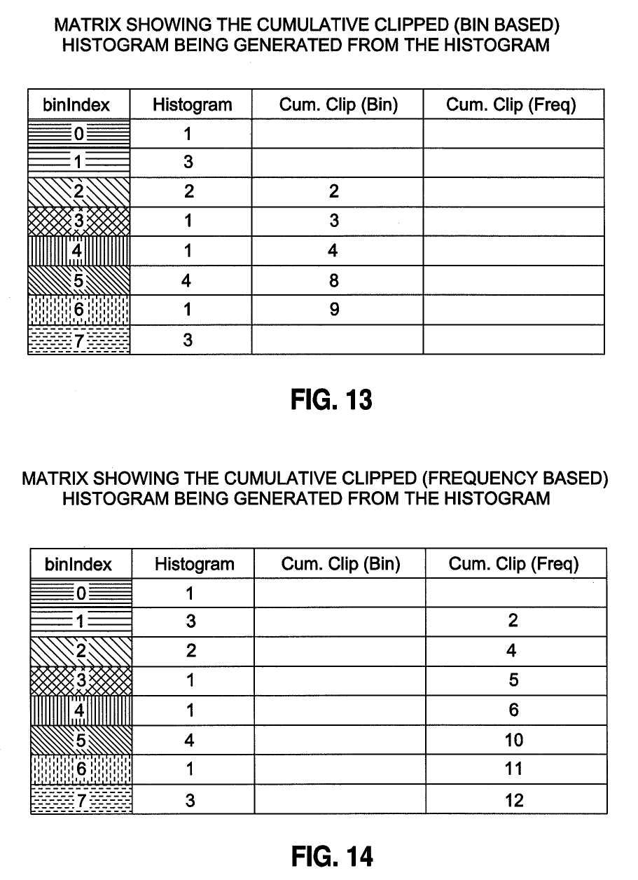

An example of clipping a cumulative histogram by specifying bin numbers is shown in FIG. 11. Generally, clipping bin numbers (CBL, CBR) are used as external parameters. The user may enter CBL and CBR, or they may be automatically decided based on the system or the application. Specifically, in the example shown in FIG. 11, a user has specified the clipping bin number left (CBL) as ‘2’, and the clipping bin number right (CBR) as ‘2’. Thus, in FIG. 11, two bins are clipped from each edge of the cumulative histogram. The resultant numerical values are shown in table form in FIG. 13.

More specifically, if the total bin numbers is M and the number of clipped bins from left and right is CBL and CBR respectively, then the range of bins whose frequency is valid is from bin [CBL] to bin [M−1−CBR]. The cumulative frequency g′ of bin[x] after clipping is as follows:

if 0≦x<CBL, g′(x)=0 (1)

if CBL≦x≦M−1−CBR, g′(x)=g(x)−g(CBL−1) (2)

if M−1−CBR<x≦M, g′(x)=g(M−1−CBR)−g(CBL−1) (3)

Applying these rules to the example shown in FIG. 11, when executing clipping while specifying CBL=2 and CBR=2 for a cumulative histogram whose total bin number is 8 , the clipping is executed for the frequencies accumulated in the range of bin [0] to bin [1] on the left side and of bin [6] to bin [7] on the right side.

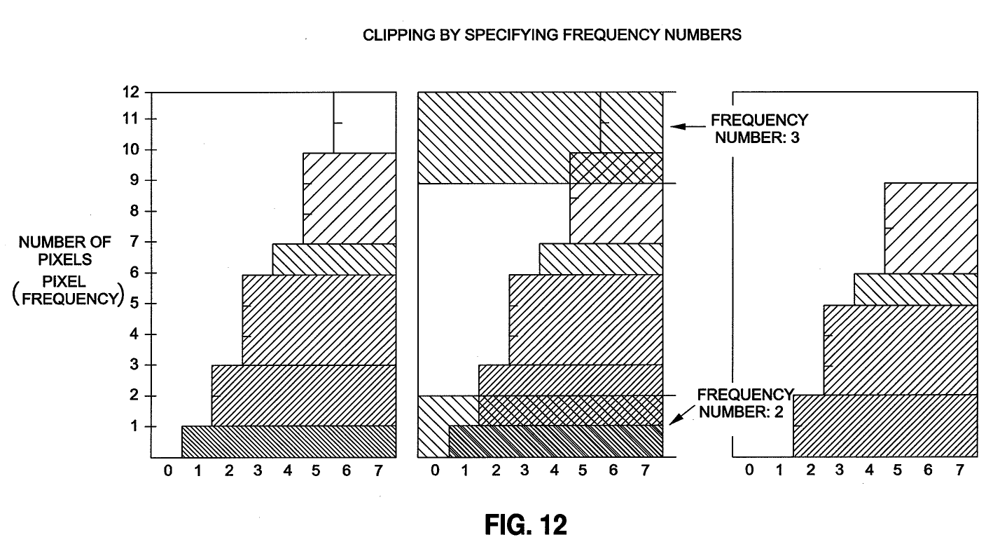

An example of frequency-based clipping processing is shown in FIG. 12. A user specifies pixel frequencies to be clipped from the left and the right edges of the histogram. Clipping frequency numbers clipping frequency left (CFL) and clipping frequency right (CFR) are used as external parameters. Similarly to CBL and CBR, the user may enter CFL and CFR, or they may be automatically decided based on the system or the application. The resultant numerical values are shown in table form in FIG. 14.

One possible method for clipping by frequency is described as follows. If the total number of pixels is N and clipping is executed with cumulative frequency of CFL from the left side and CFR from the right side of cumulative histogram, the frequency is effective from (CFL+1)st to (N−CFR)th, accumulated. Thus, if the total pixel number is N, when clipping the accumulated frequencies of left side CFL and right side CFR, the valid frequency range is from (CFL+1)th to (N−CFR)th accumulated frequency. The cumulative frequency g′ of Bin[x] after clipping is as follows:

if 0≦g(x)<CFL, g′(x)=0 (1)

if CFL≦g(x)≦N−1−CFR, g′(x)=g(x)−CFL (2)

if N−CFR<g(x)≦N, g′(x)=N−(CFL+CFR) (3)

In one embodiment, when clipping is performed continuously (specifying bin numbers or frequency numbers), only the clipping processing which is performed at the end is valid.

In some cases, clipping the histogram by bin or by frequency can lead to an increase in overall processing speed. In particular, provided that the user has specified the required external parameters CBL, CBR, CFL or CFR prior to generating the histogram, the parallel search can be altered to facilitate clipping. For example, if CBL=2 and CBR=2, processing speed can be increased by not performing the parallel search for those bin indexes. For example, in the example shown in FIG. 11, the parallel search would only be conducted (and thus bin values only generated) for the bins with bin indexes 2 to 5. In other words, the clipped bins are “skipped” in the processing, thus reducing the overall processing required.

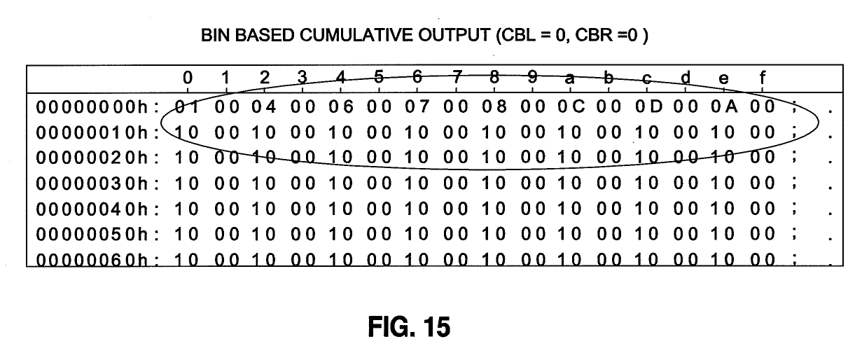

FIG. 15 shows one depiction of the output histogram, according to the input shown in FIG. 6. FIG. 11 is a 256×256 data texture which can accommodate 16 bit images (up to 65536 bins). This output can be applied to the original image to obtain a Bin-based or Frequency based clipped histogram at the output. The output is a meta-data consisting of cumulative histogram of the original image.

By performing the parallel sort and parallel search algorithms on the set of pixels of the input image, many of the disadvantages of other histogram generation methods can be reduced. In particular, the histogram can ordinarily be created more quickly and efficiently. In addition, the image data ordinarily does not require any pre-processing or segmentation, nor any thread overhead to account for shared memory and/or synchronization between threads. Moreover, the memory required for generating the histogram can ordinarily be reduced, thus allowing extra space for histogram bins for representing more detailed image data. Additionally, the histogram can ordinarily be generated without regard to the particular type of hardware being used.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for generating a histogram of an image, comprising:
inputting the image and assigning a pixel value to each pixel of the input image;
defining a set of bin indexes for the histogram, each bin index representing one or more possible numerical values for a pixel;
applying a parallel sort to the pixel values in order to generate a set of sorted pixel values;
applying, for each bin index, a parallel search to the sorted pixel values using the bin index as the target of the parallel search, in order to find the position of the bin index in the sorted pixel values;
generating, for each bin index, a number of pixels in a bin corresponding to the bin index, based on the difference between the position of the bin index in the sorted pixel values and the position of a subsequent bin index in the sorted pixel values;
generating the histogram based on the respective number of pixels in each bin corresponding to each bin index; and
storing the generated histogram in a memory.

2. The method according to claim 1, wherein an independent execution thread is provided for each pixel of the input image.

3. The method according to claim 1, wherein if the input image is a color image, a separate histogram is generated for each color channel of the input image, along with a composite histogram representing the combination of the color channels.

4. The method according to claim 3, wherein each of the color channels can be assigned a weight to be used in the generation of the composite histogram.

5. The method according to claim 4, wherein the weights are assigned to one or more channels by a user.

6. The method according to claim 1, wherein the histogram is stored in the memory in a two-dimensional data structure which stores respective positions corresponding to each bin index together with the respective number of pixels corresponding to each bin index.

7. The method according to claim 6, wherein the respective position for each bin index in the data structure is determined according to the numerical value or values represented by the bin index.

8. The method according to claim 1, wherein each pixel of the input image is held in a two-dimensional data structure, in correspondence to the respective position of the pixel in the input image.

9. The method according to claim 8, wherein all pixels of the input image are stored in the two-dimensional data structure and assigned pixel values in parallel.

10. The method according to claim 1, wherein the input image is a three-dimensional image, and wherein the histogram is stored in the memory in a three-dimensional data structure including a respective position in the data structure corresponding to each bin index.

11. The method according to claim 1, wherein each bin index corresponds to a range of possible numerical values for a pixel.

12. The method according to claim 1, wherein the generated histogram is displayed on a display screen and a user manipulates the histogram to effect changes in the image, and wherein a resultant histogram corresponding to the changes in the image is stored in the memory.

13. The method according to claim 1, wherein the generated histogram is directly applied to an image for the purposes of image processing.

14. An image processing apparatus, comprising:
a computer-readable memory constructed to store computer-executable process steps; and
a processor constructed to execute the computer-executable process steps stored in the memory;
wherein the process steps stored in the memory cause the processor to generate a histogram of an input image, and include computer-executable process steps to:
input the image and assigning a pixel value to each pixel of the input image;
define a set of bin indexes for the histogram, each bin index representing one or more possible numerical values for a pixel;
apply a parallel sort to the pixel values in order to generate a set of sorted pixel values;
apply, for each bin index, a parallel search to the sorted pixel values using the bin index as the target of the parallel search, in order to find the position of the bin index in the sorted pixel values;
generate, for each bin index, a number of pixels in a bin corresponding to the bin index, based on the difference between the position of the bin index in the sorted pixel values and the position of a subsequent bin index in the sorted pixel values;
generate the histogram based on the respective number of pixels in each bin corresponding to each bin index; and
store the generated histogram in a memory.

15. The apparatus according to claim 14, wherein an independent execution thread is provided for each pixel of the input image.

16. The apparatus according to claim 14, wherein if the input image is a color image, a separate histogram is generated for each color channel of the input image, along with a composite histogram representing the combination of the color channels.

17. The apparatus according to claim 16, wherein each of the color channels can be assigned a weight to be used in the generation of the composite histogram.

18. The apparatus according to claim 17, wherein the weights are assigned to one or more channels by a user.

19. The apparatus according to claim 14, wherein the histogram is stored in the memory in a two-dimensional data structure which stores respective positions corresponding to each bin index together with the respective number of pixels corresponding to each bin index.

20. The apparatus according to claim 19, wherein the respective position for each bin index in the data structure is determined according to the numerical value or values represented by the bin index.

21. The apparatus according to claim 14, wherein each pixel of the input image is held in a two-dimensional data structure, in correspondence to the respective position of the pixel in the input image.

22. The apparatus according to claim 21, wherein all pixels of the input image are stored in the two-dimensional data structure and assigned pixel values in parallel.

23. The apparatus according to claim 14, wherein the input image is a three-dimensional image, and wherein the histogram is stored in the memory in a three-dimensional data structure including a respective position in the structure corresponding to each bin index.

24. The apparatus according to claim 14, wherein each bin index corresponds to a range of possible numerical values for a pixel.

25. The apparatus according to claim 14, wherein the generated histogram is displayed on a display screen and a user manipulates the histogram to effect changes in the image, and wherein a resultant histogram corresponding to the changes in the image is stored in the memory.

26. A computer-readable storage medium storing a computer-executable program for causing a computer to generate a histogram of an image, the method comprising:
inputting the image and assigning a pixel value to each pixel of the input image;
defining a set of bin indexes for the histogram, each bin index representing one or more possible numerical values for a pixel;
applying a parallel sort to the pixel values in order to generate a set of sorted pixel values;
applying, for each bin index, a parallel search to the sorted pixel values using the bin index as the target of the parallel search, in order to find the position of the bin index in the sorted pixel values;
generating, for each bin index, a number of pixels in a bin corresponding to the bin index, based on the difference between the position of the bin index in the sorted pixel values and the position of a subsequent bin index in the sorted pixel values;
generating the histogram based on the respective number of pixels in each bin corresponding to each bin index; and
storing the generated histogram in a memory.
